(19) United States
(12) Patent Application Publication
(10) Pub. No.: US 2026/0168570 A1
(43) Pub. Date: Jun. 18, 2026

(54) Actuator Assembly And Transmission Comprising An Actuator Assembly

(71) Applicant: Kongsberg Automotive Holding 2 AS, Kongsberg (NO)

(72) Inventors: Bertrand Mallette, Shawinigan (CA); Simon Riverin-Gaudreau, Trois-Rivieres (CA); Vincent Kehl, Shawinigan (CA); Francis Grenier, Shawinigan (CA); Samuel Gélinas, Shawinigan (CA)

(73) Assignee: Kongsberg Automotive Holding 2 AS, Kongsberg (NO)

(21) Appl. No.: 18/711,423

(22) PCT Filed: Jan. 11, 2022
(86) PCT No.: PCT/IB2022/050191

§ 371 Date: May 17, 2024

(51) Int. Cl. F16H 61/12; F16H 61/02; F16H 61/28; F16H 61/32; F16H 61/686; F16H 63/32

(52) U.S. Cl. CPC F16H 61/12; F16H 61/0213; F16H 61/32; F16H 61/686; F16H 63/32; F16H 2061/283

(57) ABSTRACT

The teachings of the present application generally provide for an actuator assembly for actuating components of a transmission. The actuator assembly comprising a support, at least one shift actuator including a rail selector to move the rail selector between a plurality of positions along a shift axis defined by the shift actuator, and a selector actuator movable between a first position and a second position along a select axis. The rail selector is coupled to the select actuator such that the movement of the select actuator between the first position and the second position rotates the rail selector from a first radial position to a second radial position

### FIELD OF INVENTION

The subject invention relates to an actuator assembly driven by a fluid for actuating a component of a transmission and a method of operating the same.

### BACKGROUND

Machines such as, for example, on and off-highway trucks and other heavy construction and mining machines are used to perform many tasks. To effectively perform these tasks, the machines require a power source that provides significant power through a transmission to one or more ground engaging devices. The transmission must provide a range of gearing to allow the machine to work at different speeds while keeping the engine operating within a desired operating range. For this purpose, the machines typically include a multi-speed transmission connected to the engine.

To generate the wide range of gearing required by the machine, the multi-speed transmission includes a plurality of intermeshing gears and a corresponding shift mechanism also commonly known as a shift yoke or fork. The shift mechanism is used to selectively engage predetermined combinations of gears that result in a desired output ratio. For example, the shift mechanism is typically movable between three positions, namely from a first position at which a first combination of gears is selected to produce a first output gear ratio (e.g., high speed), to a second position at which no gears are engaged (e.g., neutral), and to a third position at which a second combination of gears is selected to produce a second output gear ratio (e.g., low speed).

Shift mechanisms of the type described above are typically actuated to move between the three positions with one or more actuators per shift rod and yoke. In some examples, such as in a six-speed transmission (1-6 forward gears+reverse), four separate actuators may be used to actuate each pair of gears (e.g. a first gear and a second gear on the same shaft) on each of the four rails. Unfortunately, because of the multiple actuators needed to shift the transmission, this configuration is complex, expensive, and takes up a substantial amount of space on and in the transmission.

### SUMMARY

The general teachings of the present application provide for an actuator assembly for actuating components of a transmission. The actuator assembly comprising a support, at least one shift actuator including a rail selector to move the rail selector between a plurality of positions along a shift axis defined by the shift actuator, and a selector actuator movable between a first position and a second position along a select axis. The rail selector is coupled to the select actuator such that the movement of the select actuator between the first position and the second position rotates the rail selector from a first radial position to a second radial position The present teachings further provide for a transmission system comprising: a gearbox; a first rail and a second rail disposed longitudinally within the gearbox, each of the first rail and second rail configured to move between a plurality of positions longitudinally, with each rail defining an axis. The gearbox includes a first shift fork located along the first rail and a second shift fork located along the second rail, each of the first shift fork and second shift fork being configured to engage and disengage at least one gear. The transmission system further including an actuator assembly to move each of the first shift fork and second shift fork between the plurality of positions longitudinally, the actuator assembly removably coupled with the gearbox. The actuator assembly comprises a support and at least one shift actuator connected to the support. The shift actuator including a rail selector, the shift actuator being configured to move the rail selector between a plurality of positions along a shift axis defined by the shift actuator. The actuator assembly further including a select actuator connected to the support and transverse to the at least one shift actuator. The select actuator is received by the rail selector and moves between a first position and a second position along a select axis defined by the select actuator. The select actuator moves from the first position to the second position rotating the rail selector about the longitudinal axis defined by the shift actuator from a first radial position contacting the first rail to a second radial position contacting the second rail. The first shift fork on the first rail is moved between a plurality of positions along the first rail axis when the rail selector is contacting the first rail and the shift actuator is actuated, and the second shift fork on the second rail is moved between a plurality of positions along the second rail axis when the rail selector is contacting the second rail and the shift actuator is actuated.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a perspective view of a transmission system with an actuator assembly installed on a gearbox.

FIG. 2A is a side view of the actuator assembly installed on a gearbox.

FIG. 2B is top view of the actuator assembly installed on a gearbox.

FIG. 3A is a perspective view of the actuator assembly.

FIG. 3B is a bottom perspective view of the actuator assembly.

FIG. 4 is a perspective view of the actuator assembly without the cover.

FIG. 5 is a bottom perspective view of the base support of the actuator assembly

FIG. 6 is a perspective front view of the actuator assembly.

FIG. 7 is a partial cross-sectional view of the select actuator.

FIG. 8A-8C illustrate a bottom view of the select actuator and selectors in a neutral position, a first position, and a second position, respectively.

FIG. 9 is a perspective view of the actuator assembly on the gearbox.

FIG. 10 is a perspective view of the actuator assembly and the shift rail assembly.

FIG. 11 is a perspective view of the actuator assembly and the shift rail assembly.

FIG. 12A illustrates the actuator assembly on the rail assembly in the first position.

FIG. 12B is a diagram representation of gear selection available in the first position.

FIG. 13A illustrates the actuator assembly on the rail assembly in the second position.

FIG. 13B is a diagram representation of gear selection available in the second position.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

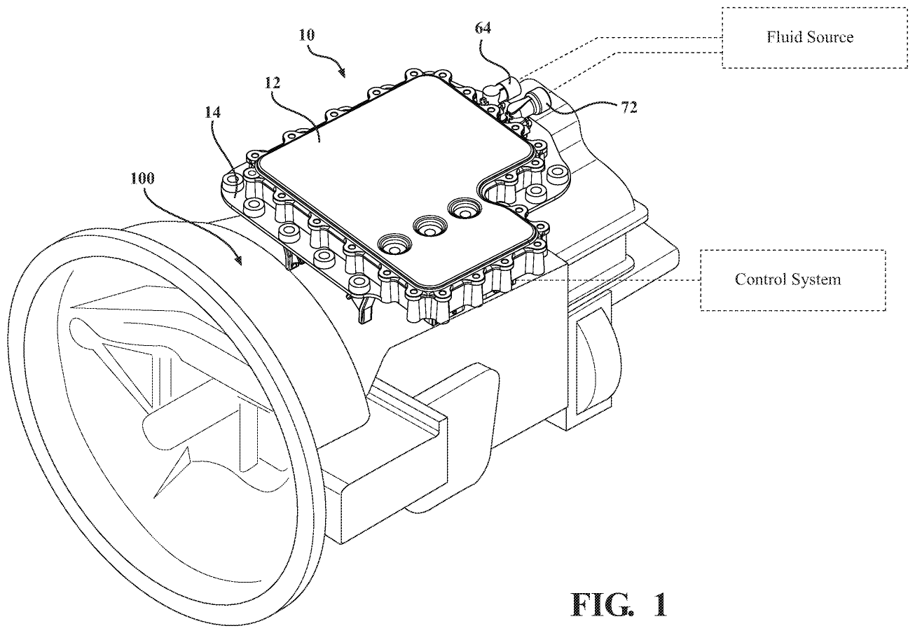

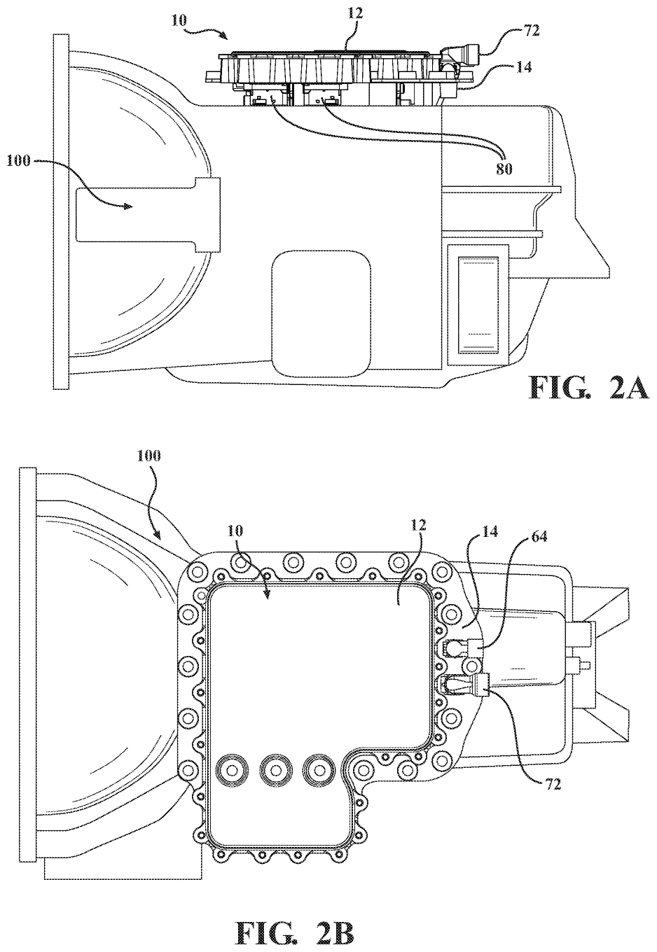

With reference to the Figures, wherein like numerals indicate like parts throughout the several views, the present teachings provide for a transmission system 1000 with an integrated actuator assembly 10 coupled with a gearbox 100. The actuator assembly 10 is configured to be integrated into the gearbox 100, such as seen in FIGS. 1 and 2A-2B. The actuator assembly 10 includes a compact design with a low profile. The actuator assembly 10 is configured to be received by gearbox 100. The actuator assembly 10 includes a cover 12 and base support 14 (also referred to as base or support). The base 14 is connected with one or more shift actuators 20, 22, at least one select actuator 24, a manifold 68 configured to receive electrical and/or fluid inputs, the cover 12, or a combination thereof.

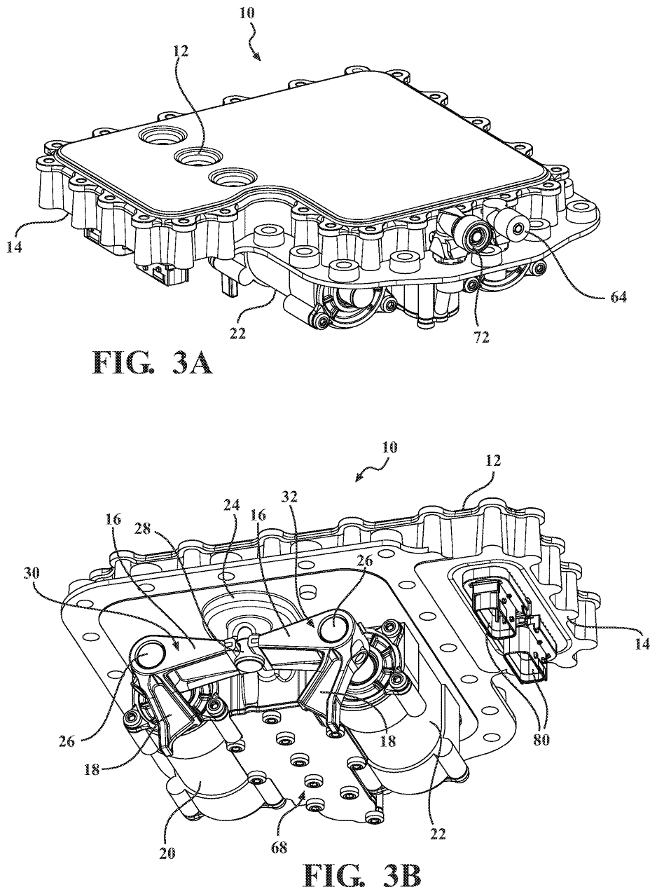

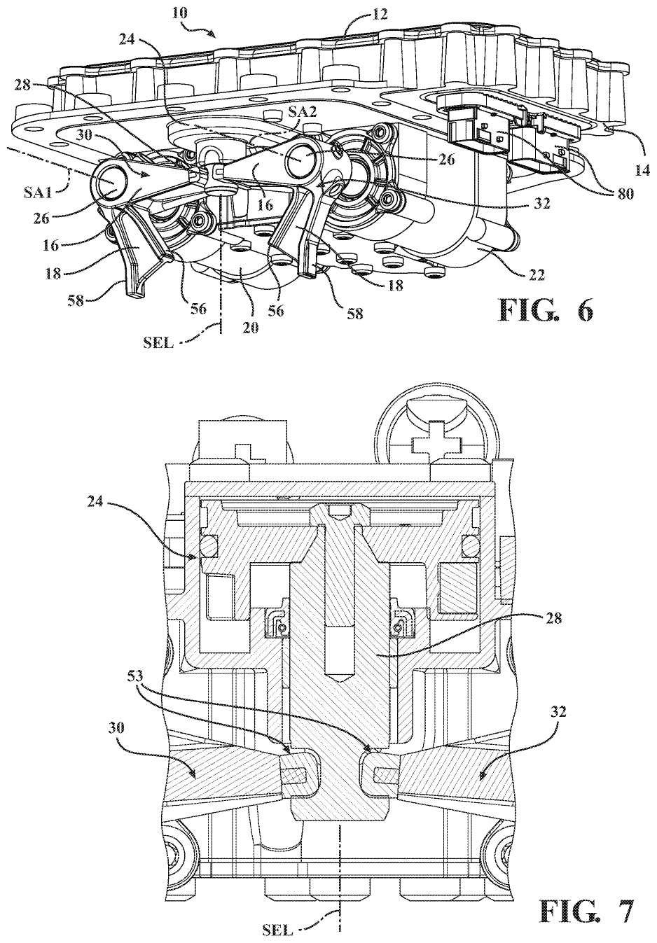

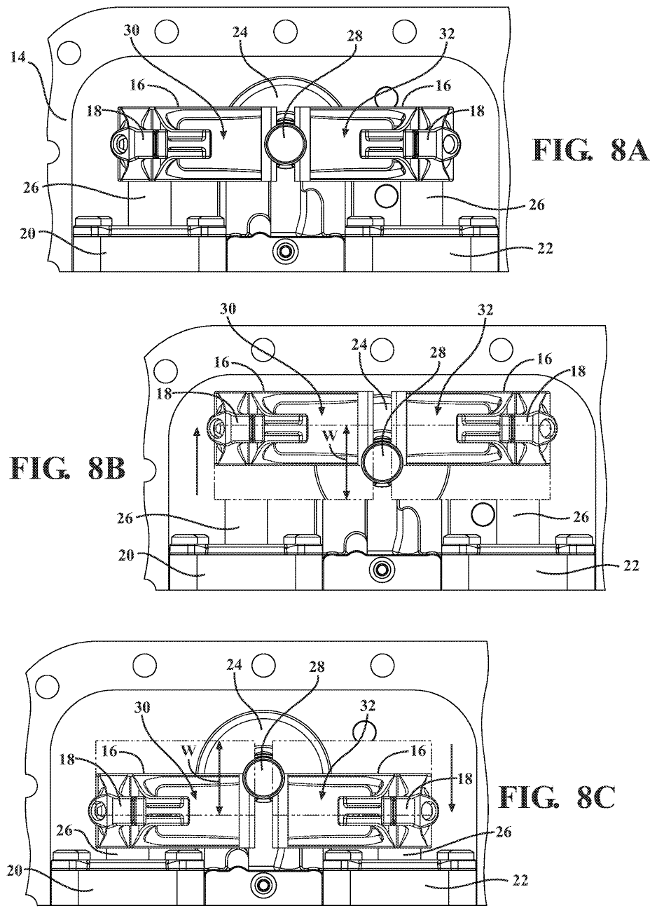

The actuator assembly 10 comprises one or more shift actuators 20, 22 and at least one select actuator 24. In at least the example shown in FIGS. 3A-3B and 4-6, the actuator assembly 10 includes shift actuators 20, 22 located along a portion of the base support 14. The shift actuators function to assist the gearbox 100 in shifting gears. The shift actuators 20, 22 may function to provide the select force to actuate one or more shift forks 42, 44, 46, 48 between a plurality of positions. The shift actuators 20, 22 are configured to move between a neutral position (FIG. 8A), a first position (FIG. 8B), and a second position (FIG. 8C). Actuation of the shift actuators 20, 22 is described below in further detail.

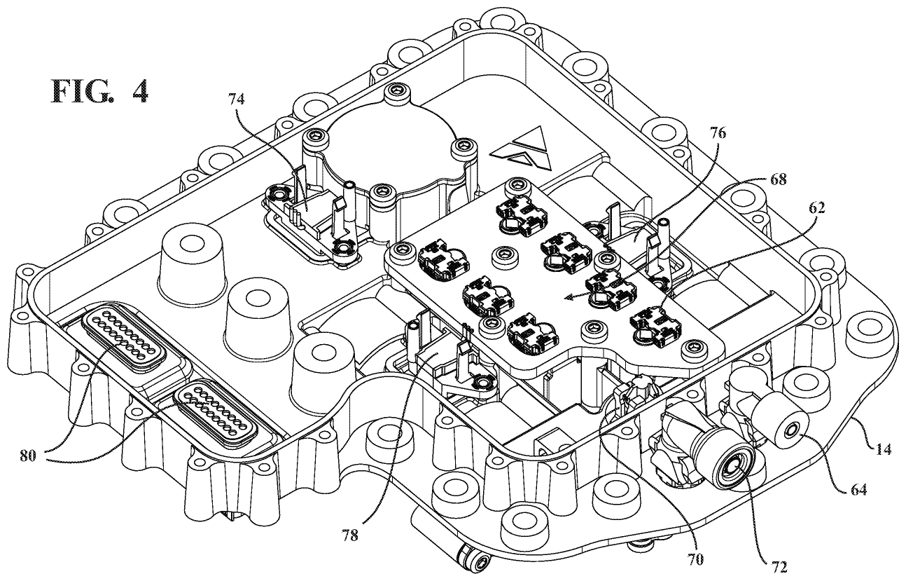

In some examples, such as shown in FIG. 4, the actuator assembly 10 is a fluid-driven actuator assembly that receives electrical and fluid signals, working in conjunction to move the shift actuators 20, 22 and select actuator 24 between a plurality of positions based on the input signals from a control system. In this example, the control system is external and connects with the actuator assembly 10 through connects 80, however, an onboard control system is contemplated. Similarly, the actuator assembly 10 is shown connected with an external fluid source, but other fluid sources, and other types of actuation are contemplated. It is contemplated that the actuator assembly may be an electric actuator assembly, a hydraulic actuator assembly, a pneumatic actuator assembly, or a combination thereof.

The base support 14 of the actuator assembly 10 functions to support the components of the actuator assembly 10. As can be seen in FIGS. 3A-5, the components of the actuator assembly 10 are connected with the base support 14 such as the cover 12, shift actuators 20, 22, select actuator 24, connectors 80, ports 64, 72, sensors 70, 74, 76, 78 and fluid distribution system 68.

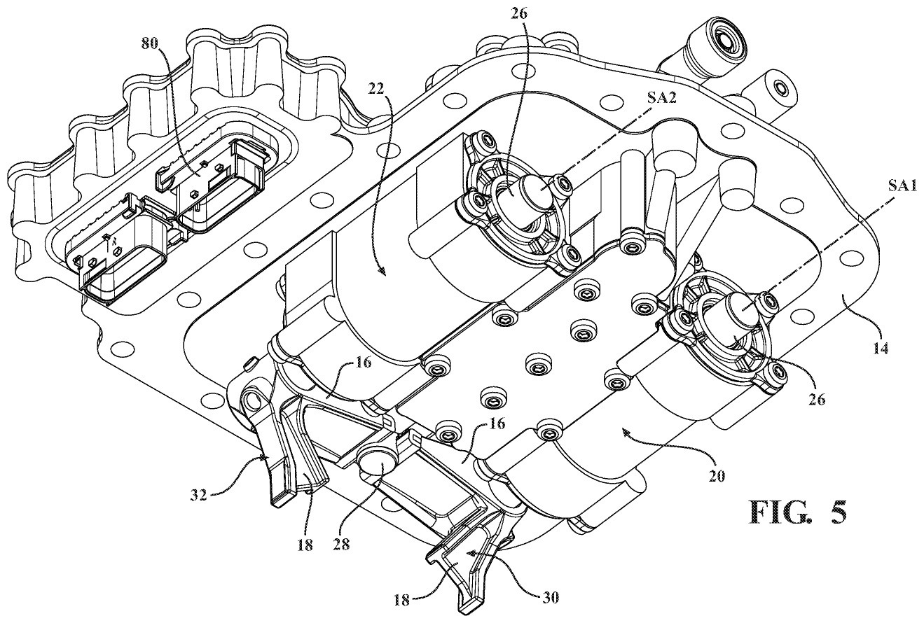

The fluid distribution system 68 functions to receive shift signals (e.g. electrical, fluid, or both) and actuate the shift actuators 20, 22 and the select actuator 24. Additionally, the fluid distribution system functions to actuate an interlocking assembly 60. The fluid distribution system 68 comprises a plurality of valves in communication with a manifold, selectively distributing fluid to the actuators. In some examples, such as shown in FIGS. 4 and 5, the fluid distribution system 68 is operatively coupled with a first supply port 72 and a second supply port 64. The first supply port 72 may be an air supply port for actuating the shift actuators 20, 22 and the select actuator 24. The second supply port 64 may be an air supply port for the interlocking assembly 60, described further below. The fluid distribution system 68 is coupled with a pressure sensor 70 for monitoring the pressure of a fluid entering the manifold.

The fluid distribution system 68 is operatively coupled with connectors 80 for receiving electrical command signals from a control system. The fluid distribution system 68 includes a plurality of valves that open and shut when a shift is commanded. The fluid distribution system 68 selectively actuates the shift actuators 20, 22 and select actuator 24 when a signal from the control system is sent to the actuator assembly 10 to shift.

The base support 14 supports sensors 74, 76, 78. Each of the sensors 74, 76, 78 are position sensors in communication with the control system for communication the position of shift actuators 20, 22, and the select actuator 24. For example, sensor 74 is a select actuator position sensor 74 and is connected with the select actuator 24 for monitoring the position of the select shaft 28 of the select actuator 24 between at least a first position and a second position along a select axis SEL. Sensor 76 and 78 are rail position sensors 76, 78. The first rail position sensor 76 monitors the position of a first shift actuator 20 and the second rail position sensor 78 monitors the position of a second shift actuator 22. The rail position sensors 76, 78 sense the position of the shift actuator shafts 26 along the shift axes SA1, SA2 to determine which position each of the shift actuators 20, 22 are in. The select axis is transverse to each of the shift axes SA1, SA2.

The actuator assembly 10 includes at least one shift actuator 20, 22 for actuating in a linear direction along a shift axis SA1, SA2. In the present example, the actuator assembly 10 includes a first shift actuator 20 and a second shift actuator 22. However, it is contemplated that the actuator assembly may only have one shift actuator 20, 22. Each of the shift actuators 20, 22 include a rotatable actuator shaft 26 connected with a rail selector 30, 32. Each of the actuator shafts 26 are configured to be actuated by the shift actuators 20, 22, moving the shafts 26 and the rail selectors 30, 32 along a shift axis SA1, SA2 defined by each of the respective shift actuators 20, 22. Each of the actuator shafts 26 are configured to rotate about their respective shift axes SA1, SA2 when the select actuator 24 is actuated between a first position and a second position. The rail selectors 30, 32 are moved between the plurality of positions along the shift axis SA1, SA2 by the actuator shaft 26 when the shift actuators 20, 22 are actuated.

Each of the shift actuators 20, 22 have a rail selector 30, 32 connected to each of the actuator shafts 26. Each of the rail selectors 30, 32 function to interface with at least two shift rails 34, 36, 38, 40, coupling to one of the at least two shift rails in a first position, and a second of the at least two shift rails in a second position. The rail selectors 30, 32 each couple with a shift rail 34, 36, 38, 40, and the rail selectors 30, 32 facilitate movement of the shift rails 34, 36, 38, 40. Each of the shift rails 34, 36, 38, 40 are coupled with a corresponding shift fork 42, 44, 46, 48. As the rail selectors 30, 32 are moved along the shift axis SA1, SA2 between a plurality of positions, the shift rails 34, 36, 38, 40 move their corresponding shift fork 42, 44, 46, 48 along longitudinal one of the axes RA1, RA2, RA3, RA4.

Each rail selector 30, 32 includes a first arm 16 and a second arm 18. The first arm 16 functions to receive the select actuator 24. The first arm 16 is dimensioned to be retained within the select actuator 24 throughout a stroke length of the shift actuator 20, 22. For example, the first arm 16 of the rail selector 30, 32 has a width corresponding to a stroke length of the shift actuator 20, 22 such that the first arm 16 is maintained in the detent 54 of the select shaft 28 of the select actuator 24 as the shift actuator 20, 22 moves between the plurality of positions along the shift axis SA1, SA2. The first arm 16 works with the select actuator 24 to position the second arm 18 into communication with a particular shift rail 34, 36, 38, 40, depending on the position of the select actuator 24.

The second arm 18 of the rail selectors 30, 32 extends in a different direction than the first arm 16. The second arm 18 functions to interface with two separate rails 34, 36, 38, 40 within the gearbox 100, one shift rail per position along the select axis SEL, which is described further below. The second arm 18 includes an inner rail interface 56 on a proximal surface and an outer rail interface 58 on a distal surface of the second arm 18. The outer rail interface extends further from the shift axis than the inner interface. The first arm 16 and second arm 18 are fixed relative to each other. The first arm 16 and the second arm 18 are arranged at a fixed angle relative to each other and the shift axis SA1, SA2.

FIGS. 8A-8C show one example of the rail selectors 30, 32 moving a stroke length with the shift actuators 20, 22 along the shift axes SA1, SA2. FIG. 8A illustrates the shift actuator 20, 22 in a neutral position, with the select shaft 28 of the select actuator 24 approximately at a midline of the first arm 16. FIG. 8B illustrates the shift actuators 20, 22 in a first position, moving the rail selectors 30, 32 to a position away from the shift actuators 20, 22, advancing the shift actuator shafts 26 and rail selectors 30, 32 along the shift axis SA1, SA2. The first arm 16 of the rail selectors 30, 32 are moved along their width W such that a portion of the first arm 16 is still retained by the select shaft 28 of the select actuator 24. Similarly, FIG. 8C illustrates the shift actuators in a second position with the rail selectors 30, 32 pulled towards the shift actuators 20, 22 along the shift axis SA1, SA2. The first arm 16 of the rail selectors 30, 32 is moved along the width W such that a portion of the first arm 16 is retained by the select shaft 28 of the select actuator 24.

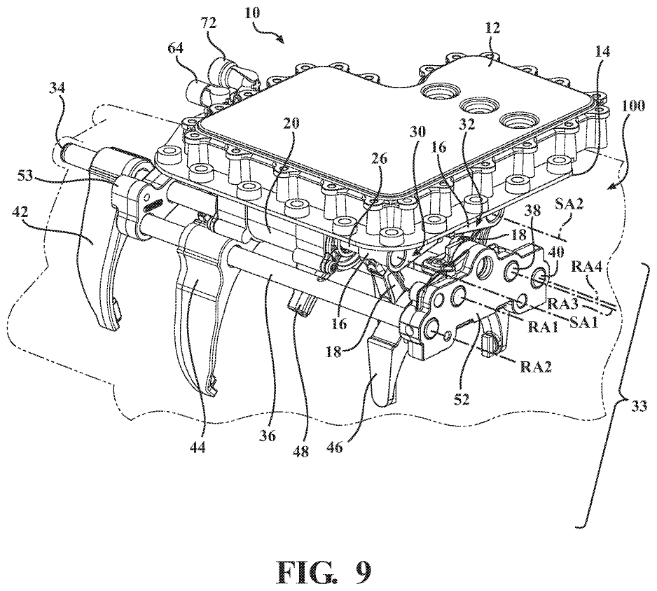

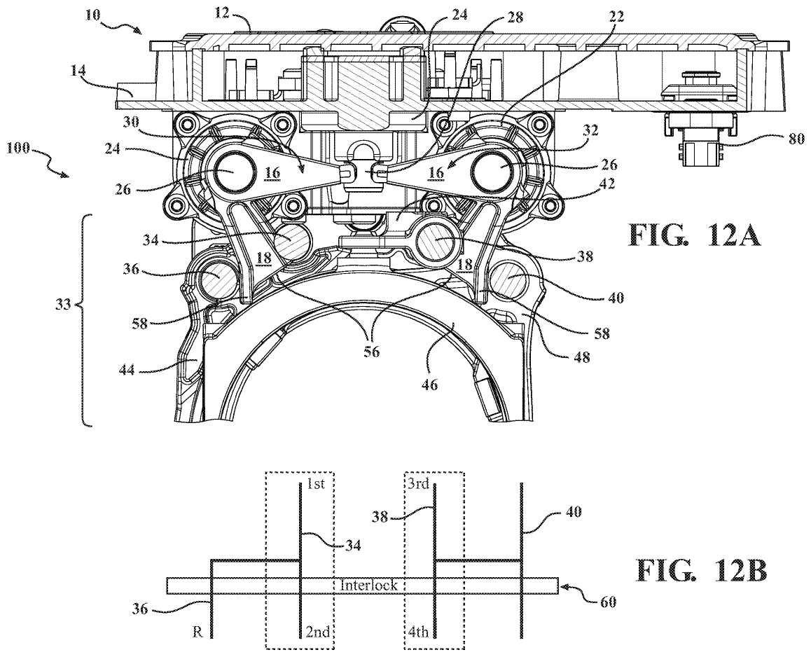

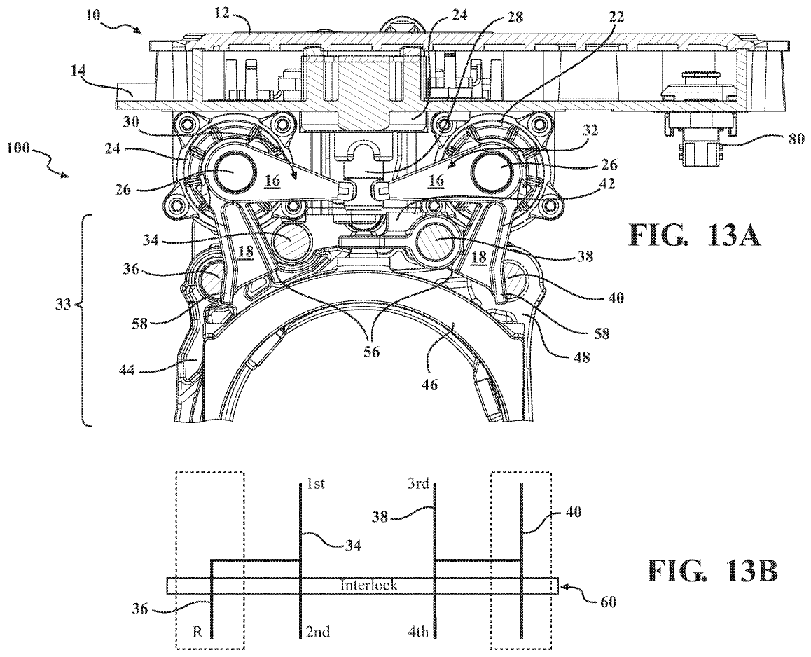

The actuator assembly includes a select actuator 24. The select actuator functions to transition the rail selectors 30, 32 between a first position (FIG. 12A) and a second position (FIG. 13A). The select actuator 24 includes a select shaft 28. The select actuator shaft 28 is moved along the select axis SEL between a first position and a second position when the select actuator 24 is actuated. The select actuator shaft 28 is configured to receive at least one rail selector 30, 32. As seen in FIG. 7, the select actuator shaft 28 receives the first arm 16 of rail selectors 30, 32 in detents 54. As described above, the first arm 16 of rail selectors 30, 32 move through detents 54 as the shift actuators 20, 22 are moved between positions along the shift axes SA1, SA2. When the actuator assembly is coupled with a gearbox 100, such as shown in FIGS. 9-13B, the select actuator 24 positions each of the rail selectors 30, 32 into communication between a first shift rail 34, 38 and a second shift rail 36, 40 when the select actuator 24 is moved between the first position and the second position. The select actuator 24 is located between the shift actuators 20, 22. In some examples, it is contemplated that the actuator assembly 10 may only have one shift actuator 20, 22 and one select actuator 24.

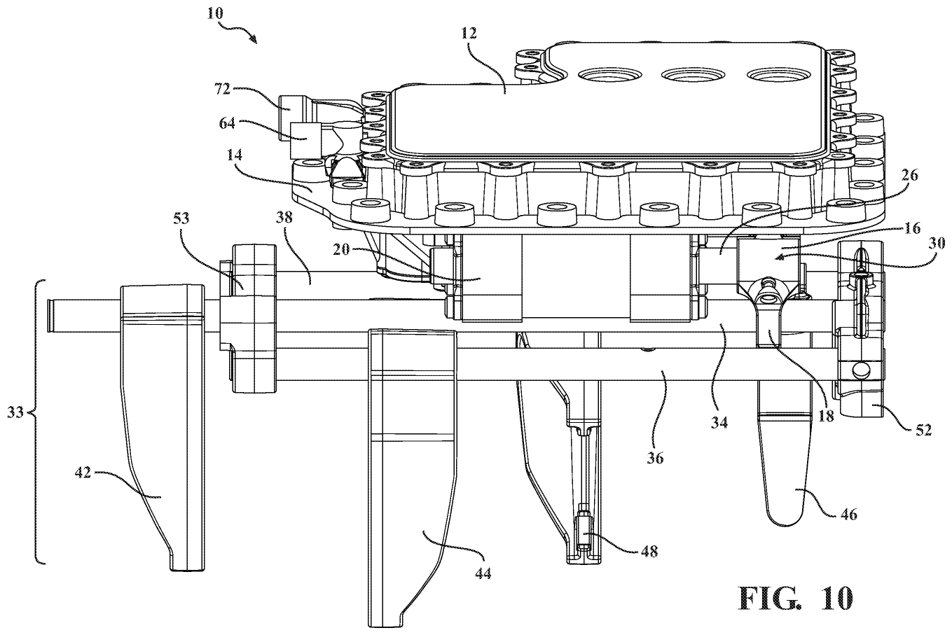

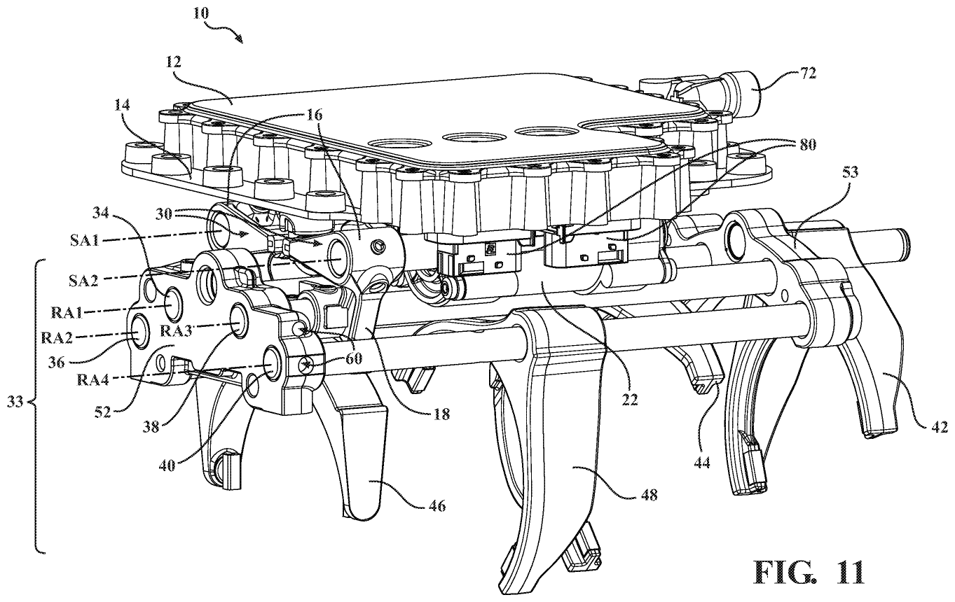

Turning to FIGS. 9-11, the actuator assembly 10 is shown disposed with a shift rail assembly 33. FIG. 9 illustrates the shift rail assembly 33 and actuator assembly 10 within a gearbox 100. In FIGS. 10 and 11, the shift rail assembly 33 has been removed from the gearbox 100 to illustrate the actuator assembly 10 integration into the rail assembly 33 more clearly. Each of the shift rails 34, 36, 38, 40 are coupled with a corresponding shift fork 42, 44, 46, 48, respectively. Each of the shift rails 34, 36, 38, 40 each define a longitudinal axis RA1, RA2, RA3, RA4. As seen in FIGS. 9-11, the rails are secured by a first rail retainer 52 and a second rail retainer 53. The rail retainers 52, 53 maintain the position of the rails 34, 36, 38, 40 while allowing each of the rails to slide axially. The interlock assembly may include a linear actuator (not shown) which is coupled with the gearbox 100 and configured to interface with rail retainer 52 and the plurality of rails 34, 36, 38, 40. The interlock assembly 60 interfaces with the first rail retainer 52 and each of the rails 34, 36, 38, 40 to prevent subsequent movement of the shift forks 42, 44, 46, 48, preventing the transmission from shifting.

FIGS. 12A-12B and 13A-13B depict a partial cross section of a front view of the shift rail assembly 33 and the actuator assembly 10, showing the rail selectors 30, 32 interfacing with the shift rails 34, 36, 38, 40. FIG. 12A shows the select actuator 24 in the first position such that the inner rail interface 56 of the rail selectors 30, 32 are contacting rails 34, 38. FIG. 12B schematically shows movement gears of the transmission 100 that are engaged when the shift actuators 20, 22 are actuated. In some examples, as the shift actuators 20 is moved from the neutral position along the shift axis SA1, a first forward gear and a second forward gear are engaged and disengaged by the shift fork 42 along shift rail 34. As shift actuator 22 is moved along the shift axis SA2, a third forward gear and a fourth forward gear are engaged and disengaged by the shift fork 46 along shift rail 38. The actuator assembly 10 is configured to actuate the four most used gears of the drive train to provide for the quickest shifting. Therefore, the actuator assembly 10 is designed with the transmission 100, particularly the rail assembly and corresponding gears, so that the most used gears during normal operation are on rails that are located such that the select actuator is in the same position to allow the shift actuators to actuate the most commonly used gears during normal operation. In the present example, as shown in FIG. 12B, the most used gears are the first gear and second gear on rail 34, and the third gear and fourth gear on rail 38. As described above, the select actuator 24 is in the first position allowing the select actuators 20, 22 to switch between these gears without the select actuator 24 having to change position. Additionally, FIG. 12B schematically depicts the interlock assembly 60 relative the shift rails 34, 36, 38, 40. When actuated, the interlock assembly will prevent the shift rails 34, 36, 38, 40 from moving axially.

Similarly, FIG. 13A shows the select actuator 24 in the second position such that the outer rail interface 58 of the rail selectors 30, 32 are contacting rails 36, 40. FIG. 13B schematically shows the movement gears of the transmission 100 that are engaged when the shift actuators 20, 22 are actuated. In some examples, as the shift actuators 20 is moved from the neutral position along shift axis SA1, a reverse gear is engaged and disengaged by the shift fork 44 along shift rail 36, and as shift actuator 22 is moved between positions along shift axis SA2, a fifth forward gear and a sixth forward gear are engaged and disengaged by the shift fork 48 along shift rail 40. FIG. 13B also schematically depicts the interlock assembly 60 relative to the shift rails 34, 36, 38, 40.

Several examples have been discussed in the foregoing description. However, the examples discussed herein are not intended to be exhaustive or limit the teachings to any particular form. The terminology that has been used is intended to be in the nature of words of description rather than of limitation. Many modifications and variations are possible in light of the above teachings and may be practiced otherwise than as specifically described.

What is claimed is:

1. An actuator assembly for actuating components of a transmission, the actuator assembly comprising:
a support;
at least one shift actuator connected to the support, the shift actuator including a rail selector to move the rail selector between a plurality of positions along a shift axis defined by the shift actuator; and
a selector actuator connected to the support and movable between a first position and a second position along a select axis;
wherein the rail selector is coupled to the select actuator such that movement of the select actuator between the first position and the second position rotates the rail selector from a first radial position to a second radial position.

2. The actuator assembly of claim 1, wherein the rail selector includes a first arm and a second arm, the first arm being coupled to receive the select actuator and the second arm extending in a different direction than the first arm.

3. The actuator assembly of claim 2, wherein the first arm and the second arm are fixed relative to each other and arranged at a fixed angle relative to the shift axis.

4. The actuator assembly of claim 2, wherein the selector actuator includes a shaft with a detent to receive the first arm of the rail selector, wherein the first arm engages the detent to couple the rail select to the select actuator

5. The actuator assembly of claim 1, wherein the at least one shift actuator is further defined as a first shift actuator and a second shift actuator, the first shift actuator including a first rail selector and the second shift actuator including a second rail selector.

6. The actuator assembly of claim 5, wherein the first shift actuator and the second shift actuator each include a rotatable shaft attached to the first rail selector and the second rail selector, respectively.

7. The actuator assembly of claim 6, wherein the selector actuator receives a portion of each of the first rail selector and the second rail selector such that the selector actuator rotates the first rail selector and the second rail selector between the first radial position and the second radial position.

8. The actuator assembly of claim 4, wherein the first arm of the rail selector has a first width corresponding to a stroke length of the shift actuator such that the first arm is maintained in the detent of the shaft of the select actuator as the shift actuator moves between the plurality of positions along the shift axis.

9. The actuator assembly of claim 2, wherein the second arm of the rail selector includes an inner rail interface located on a first surface and an outer rail interface located on a second surface, the outer rail interface extending further from the shift axis than the inner rail interface.

10. The actuator assembly of claim 1, wherein the select axis is transverse to the shift axis.

11. A transmission system comprising:
a gearbox comprising:
a first rail and a second rail disposed longitudinally within the gearbox, each of the first rail and second rail configured to move between a plurality of positions longitudinally, the first rail defining a first rail axis, and the second rail defining a second rail axis;
a first shift fork located along the first rail and a second shift fork located along the second rail, each of the first shift fork and second shift fork is configured to engage and disengage at least one gear;
an actuator assembly to move each of the first shift fork and second shift fork between the plurality of positions longitudinally, the actuator assembly removably coupled with the gearbox, the actuator assembly comprising:
a support;
at least one shift actuator connected to the support, the shift actuator including a rail selector, the shift actuator being configured to move the rail selector between a plurality of positions along a shift axis defined by the shift actuator; and
a select actuator connected to the support and transverse to the at least one shift actuator, the select actuator received by the rail selector and moves between a first position and a second position along a select axis defined by the select actuator;
wherein the select actuator moves from the first position to the second position rotating the rail selector about the axis defined by the shift actuator from a first radial position contacting the first rail to a second radial position contacting the second rail;
wherein the first shift fork on the first rail is moved between a plurality of positions along the first rail axis when the rail selector is contacting the first rail and the shift actuator is actuated, and the second shift fork on the second rail is moved between a plurality of positions along the second rail axis when the rail selector is contacting the second rail and the shift actuator is actuated.

12. The transmission system of claim 11 further comprising a control system in communication with the actuator assembly.

13. The transmission system of claim 12, wherein the actuator assembly further comprises a fluid distribution system, the fluid distribution system being configured to receive input signals from the control system and one or more fluid sources.

14. The transmission system of claim 13, wherein the fluid source is compressed air.

15. The transmission system of claim 11, wherein the gearbox further includes a third rail and a fourth rail, and the at least one shift actuator is a first shift actuator with a first rail selector and a second shift actuator with a second rail selector.

16. The transmission system of claim 15, wherein the first shift actuator and the second shift actuator each include a rotatable shaft attached to their respective rail selector.

17. The transmission system of claim 16, wherein the select actuator receives a portion of the first rail selector and a portion of the second rail selector such that the select actuator rotates the first rail selector and the second rail selector between the first radial position and the second radial position.

18. The transmission system of claim 17, wherein the second rail selector contacts a third rail when the select actuator is in the first position, the third rail defining a third rail axis, and a fourth rail when the select actuator is in the second position, the fourth rail defining a fourth rail axis.

19. The transmission system of claim 18, wherein the first shift actuator and the second shift actuator are configured to move their respective rail selectors between the plurality of positions, moving the shift forks between the plurality of positions.

20. An actuator assembly driven by a fluid configured to move a plurality of shift forks between a plurality of positions longitudinally, the actuator assembly comprising:
a support;
a first shift actuator and a second shift actuator connected to the support, each of the shift actuators including a rail selector, each of the first shift actuator and the second shift actuators being configured to move each of the rail selectors between a plurality of positions along a first shift axis defined by the first shift actuator and a second shift axis defined by the second shift actuator, respectively; and
a select actuator connected to the support and configured to be received by the rail selector; the select actuator is configured to move between a first position and a second position along a select axis defined by the select actuator;
wherein the select actuator moves from the first position to the second position rotating the first rail selector about the first shift axis and the second rail selector about the second shift axis from a first radial position to a second radial position;
wherein the first rail selector is configured to interface with a first rail axis in the first radial position and a second rail axis in the second radial position, and the second rail selector is configured to interface with a third rail axis in the first radial position and a fourth rail axis in the second radial position.
